(19) United States
(12) Patent Application Publication
(10) Pub. No.: US 2025/0078486 A1
(43) Pub. Date: Mar. 6, 2025

(54) ELECTRONIC DEVICE AND OPERATION METHOD THEREOF FOR MULTIMODAL TEMPORAL-AXIS FUSION ARTIFICIAL INTELLIGENCE MODELS

(71) Applicant: PYLER CO., LTD., Seoul (KR)

(72) Inventors: Dong Chan PARK, Seoul (KR); Mobeen AHMAD, Seoul (KR)

(73) Assignee: PYLER CO., LTD., Seoul (KR)

(21) Appl. No.: 18/809,395

(22) Filed: Aug. 20, 2024

(30) Foreign Application Priority Data
Sep. 4, 2023 (KR) 10-2023-0116664
Feb. 29, 2024 (KR) 10-2024-0029703

(51) Int. Cl. G06V 10/80; G06V 10/62; G06V 10/764; G06V 30/18

(52) U.S. Cl. CPC G06V 10/806; G06V 10/62; G06V 10/764; G06V 30/18

(57) ABSTRACT

An electronic device for multimodal temporal-axis fusion artificial intelligence models is proposed. The electronic device comprises a storage unit, and a processor, wherein the processor may obtain a plurality of first visual features respectively corresponding to a plurality of different time points or time periods from a video, obtain a plurality of text features respectively corresponding to the plurality of time points or time periods from text, obtain a plurality of first local fusion features, respectively corresponding to the plurality of time points or time periods, from the plurality of first visual features and the plurality of text features by fusing the first visual features and the text features, which correspond to a same time point or time period, and obtain at least one global fusion feature from the plurality of first local fusion features.

### CROSS REFERENCE TO RELATED APPLICATION

This application claims the benefit of priority of Korean Patent Application Nos. 10-2023-0116664, filed on Sep. 4, 2023, and 10-2024-0029703, filed on Feb. 29, 2024, the contents of which are incorporated by reference as if fully set forth herein in their entirety.

### FIELD AND BACKGROUND OF THE INVENTION

### Field of the Invention

The present disclosure relates to an electronic device and an operation method thereof. More particularly, the present disclosure relates to an electronic device and an operation method thereof for multimodal temporal-axis fusion artificial intelligence models.

### Description of the Related Art

Research on multimodal artificial intelligence models capable of comprehensively utilizing different types of input is actively underway. Recently, beyond still image-text multimodal artificial intelligence models, research on video-text multimodal artificial intelligence models has been receiving great attention. The existing video-text multimodal artificial intelligence models have used a method of obtaining aggregated visual vectors from a video, obtaining text vectors from text, and fusing the aggregated visual vectors and the text vectors, whereby there are limitations in the performance of existing video-text multimodal artificial intelligence models because the visual features and the text features are not precisely fused on a temporal axis.

### SUMMARY OF THE INVENTION

An objective of the present disclosure for solving the problem described above is to provide an electronic device and an operation method thereof for video-text multimodal artificial intelligence models with improved performance.

According to exemplary embodiments of the present disclosure, there is provided an electronic device for multimodal temporal-axis fusion artificial intelligence models, the electronic device including: a storage unit; and a processor, wherein the processor may obtain a plurality of first visual features respectively corresponding to a plurality of different time points or time periods from a video, obtain a plurality of text features respectively corresponding to the plurality of time points or time periods from text, obtain a plurality of first local fusion features, respectively corresponding to the plurality of time points or time periods, from the plurality of first visual features and the plurality of text features by fusing the first visual features and the text features, which correspond to a same time point or time period, and obtain at least one global fusion feature from the plurality of first local fusion features.

According to exemplary embodiments of the present disclosure, there is provided an operation method of an electronic device for multimodal temporal-axis fusion artificial intelligence models, the operation method including: obtaining a plurality of first visual features respectively corresponding to a plurality of different time points or time periods from a video; obtaining a plurality of text features respectively corresponding to the plurality of time points or time periods from text; obtaining a plurality of first local fusion features, respectively corresponding to the plurality of time points or time periods, from the plurality of first visual features and the plurality of text features by fusing the first visual features and the text features, which correspond to a same time point or time period; and obtaining at least one global fusion feature from the plurality of first local fusion features.

According to the exemplary embodiments of the present disclosure, the embodiments of the present disclosure are configured to extend a text feature along a temporal axis, locally fuse a visual feature and the text feature at each time point or time period, and globally fuse local fusion features on the temporal axis across multiple time points or time periods, i.e., perform multilevel temporal-axis fusion, whereby the performance of video-text multimodal artificial intelligence models may be improved by enabling finer and more complete fusion of the visual features and the text features.

### BRIEF DESCRIPTION OF THE SEVERAL VIEWS OF THE DRAWINGS

FIG. 1 is a block diagram illustrating an electronic device for multimodal temporal-axis fusion artificial intelligence models according to the exemplary embodiments of the present disclosure.

FIG. 2 is a conceptual diagram illustrating a multimodal temporal-axis fusion artificial intelligence model according to the exemplary embodiments of the present disclosure.

FIG. 3 is a conceptual diagram illustrating a text feature extraction module used in the electronic device according to the exemplary embodiments of the present disclosure.

FIG. 4 is a conceptual diagram illustrating a first local fusion module used in the electronic device according to the exemplary embodiments of the present disclosure.

FIG. 5 is a conceptual diagram illustrating a first visual feature extraction module used in the electronic device according to the exemplary embodiments of the present disclosure.

FIG. 6 is a conceptual diagram illustrating an object graph extraction module used in the electronic device according to the exemplary embodiments of the present disclosure.

FIG. 7 is a conceptual diagram illustrating a multimodal temporal-axis fusion artificial intelligence model according to exemplary embodiments of the present disclosure.

FIGS. 8 and 9 are conceptual diagrams illustrating the multimodal temporal-axis fusion artificial intelligence models according to the exemplary embodiments of the present disclosure.

FIGS. 10 to 20 are flowcharts illustrating an operation method of an electronic device according to the exemplary embodiments of the present disclosure.

### DESCRIPTION OF SPECIFIC EMBODIMENTS OF THE INVENTION

Hereinafter, an operation principle of preferred exemplary embodiments of the present disclosure will be described in detail with reference to the attached drawings. In addition, when the exemplary embodiments of the present disclosure are described, the detailed description will be omitted in a case where it is determined that a detailed description of a related known function or configuration may obscure the gist of the present disclosure. In addition, the terms used below are terms defined in consideration of the functions in the present disclosure, and may vary depending on the intention or practice of users or operators. Therefore, the definitions of the terms used herein should be interpreted on the basis of the content and corresponding functions throughout the present specification.

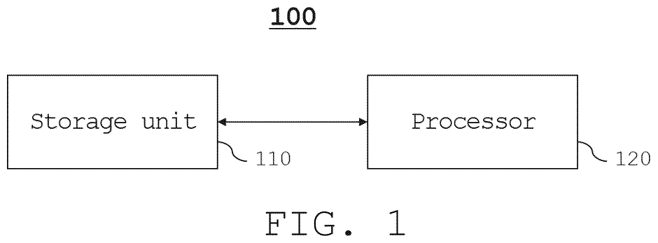

FIG. 1 is a block diagram illustrating an electronic device for multimodal temporal-axis fusion artificial intelligence models according to the exemplary embodiments of the present disclosure. Referring to FIG. 1, the electronic device 100 may include a storage unit 110 and a processor 120.

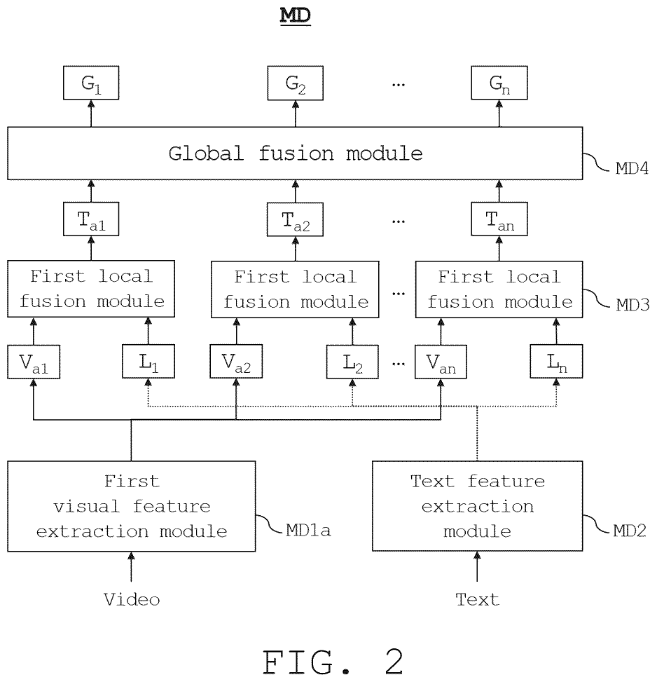

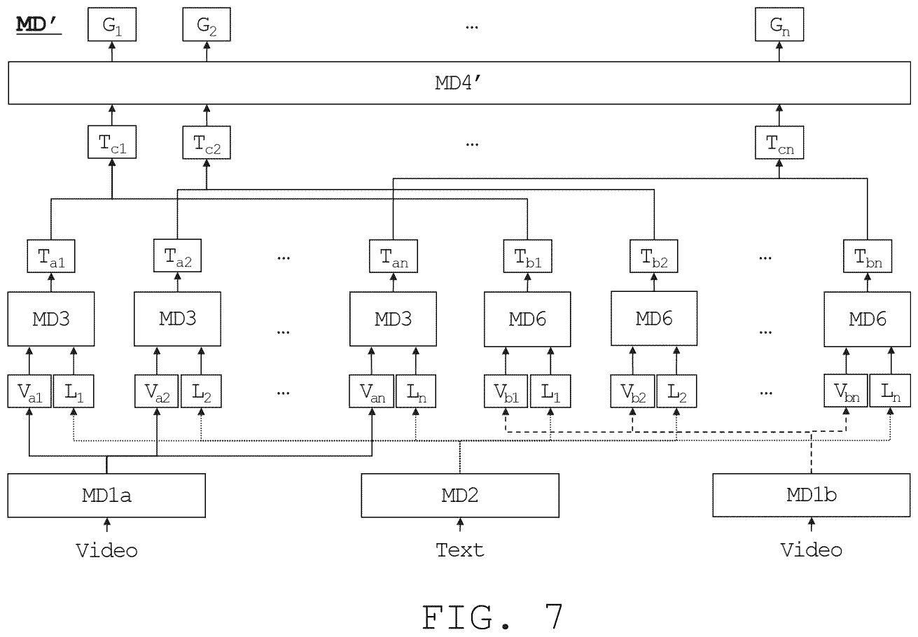

The storage unit 110 may store various kinds of data and programs. For example, the storage unit 110 may store multimodal temporal-axis fusion artificial intelligence models MD and MD′ (see FIGS. 2 and 7, respectively). In the exemplary embodiment, the storage unit 110 may store video data and text data, which are input to the artificial intelligence models. The storage unit 110 may include at least one of a volatile memory and a non-volatile memory. For example, the volatile memory may include a DRAM, a SRAM, a SDRAM, a DDR SDRAM, a FeRAM, an MRAM, a PRAM, a PoRAM, or a ReRAM. For example, the non-volatile memory may include a flash memory, a mask ROM, a PROM, an OTPROM, an EPROM, an EEPROM, a hard disk, or an optical disk.

The processor 120 may control the overall operation of the electronic device 100. The processor 120 may control the storage unit 110. For example, the processor 120 may include at least one of a central processing unit (CPU) and a graphics processing unit (GPU).

In the exemplary embodiment, the processor 120 may obtain a plurality of first visual features respectively corresponding to a plurality of different time points or time periods from a video, obtain a plurality of text features respectively corresponding to the plurality of time points or time periods from text, obtain a plurality of first local fusion features, respectively corresponding to the plurality of time points or time periods, from the plurality of first visual features and the plurality of text features by fusing the first visual features and the text features, which correspond to a same time point or time period, and obtain at least one global fusion feature from the plurality of first local fusion features.

In the exemplary embodiment, in order to obtain the plurality of text features, the processor 120 may obtain the plurality of text features respectively corresponding to the plurality of time points or time periods from the text by using a plurality of mapping layers respectively corresponding to the plurality of time points or time periods.

In the exemplary embodiment, in order to obtain the plurality of text features, the processor 120 may obtain a plurality of first intermediate text features from the text, obtain a plurality of second intermediate text features respectively corresponding to the plurality of time points or time periods from the plurality of first intermediate text features by using a plurality of mapping layers respectively corresponding to the plurality of time points or time periods, and obtain the plurality of text features from the plurality of second intermediate text features by changing dimensions of the second intermediate text features.

In the exemplary embodiment, the number of the plurality of first intermediate text features may be different from the number of the plurality of second intermediate text features.

In the exemplary embodiment, a dimension of each of the plurality of text features may be a same as a dimension of each of the plurality of first visual features.

In the exemplary embodiment, in order to obtain the plurality of first local fusion features, the processor 120 may obtain the first local fusion features from the first visual features and the text features by using convolution.

In the exemplary embodiment, in order to obtain the plurality of first local fusion features, the processor 120 may obtain a plurality of first intermediate local fusion features from the first visual features and the text features, obtain a plurality of second intermediate local fusion features from the first intermediate local fusion features by using convolution, and obtain the first local fusion features from the first visual features and the second intermediate local fusion features.

In the exemplary embodiment, in order to obtain the plurality of first visual features, the processor 120 may obtain a plurality of object features from the video, obtain a plurality of object graphs from the plurality of object features, and obtain the plurality of first visual features from the plurality of object graphs.

In the exemplary embodiment, the processor 120 may obtain a plurality of second visual features respectively corresponding to the plurality of time points or time periods from the video, obtain a plurality of second local fusion features, respectively corresponding to the plurality of time points or time periods, from the plurality of second visual features and the plurality of text features by fusing the second visual features and the text features, which correspond to the same time point or time period, obtain a plurality of third local fusion features respectively corresponding to the plurality of time points or time periods from the plurality of first local fusion features and the plurality of second local fusion features, and obtain the at least one global fusion feature from the plurality of third local fusion features.

In the exemplary embodiment, in order to obtain the at least one global fusion feature, the processor 120 may obtain the at least one global fusion feature from the plurality of first local fusion features by using self-attention.

In the exemplary embodiment, the text includes a question, and the processor 120 may obtain an answer to the question by using the at least one global fusion feature.

In the exemplary embodiment, the at least one global fusion feature includes a plurality of global fusion features, and in order to obtain the answer to the question, the processor 120 may obtain an aggregated vector from the plurality of global fusion features, obtain a plurality of option features respectively from a plurality of options, and obtain the answer to the question from the aggregated vector and each option feature.

In the exemplary embodiment, the processor 120 may classify, search, predict, or generate the video by using the at least one global fusion feature.

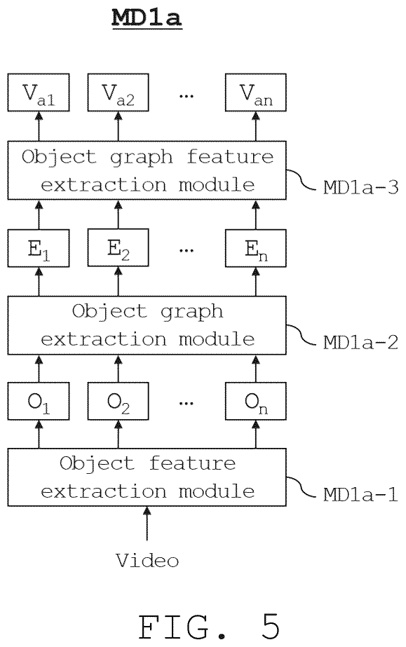

FIG. 2 is a conceptual diagram illustrating a multimodal temporal-axis fusion artificial intelligence model according to the exemplary embodiments of the present disclosure. Referring to FIG. 2, the multimodal temporal-axis fusion artificial intelligence model MD may include a first visual feature extraction module MD1a for obtaining a plurality of first visual features Vₐ₁ to Vₐₙ respectively corresponding to a plurality of different time points or time periods from a video. In the exemplary embodiment, the first visual feature extraction module MD1a may include a first visual feature extraction module MD1a as shown in FIG. 5. The processor 120 (see FIG. 1) may obtain the plurality of first visual features Vₐ₁ to Vₐₙ respectively corresponding to the plurality of different time points or time periods from the video by using the first visual feature extraction module MD1a. Hereinafter, unless otherwise specified, the processor 120 refers to the processor 120 in FIG. 1.

In the exemplary embodiment, the first visual feature extraction module MD1a may include at least one of an AlexNet (Krizhevsky et al., ImageNet Classification with Deep Convolutional Neural Networks, NIPS 2012), a VGGNet (Simonyan et al., Very Deep Convolutional Networks for Large-Scale Image Recognition, ICLR 2015), a GoogleNet (Szegedy et al., Going Deeper with Convolutions, CVPR 2015), an ResNet (He et al., Deep Residual Learning for Image Recognition, CVPR 2016), and a ViT (Dosovitskiy et al., An Image is Worth 16×16 Words: Transformers or Image Recognition at Scale, ICLR 2021).

In the exemplary embodiment, the video may be an advertising video. In the exemplary embodiment, the video may include a plurality of frames respectively corresponding to a plurality of different time points, and each frame may be a still image.

In the exemplary embodiment, each of the first visual features Vₐ₁ to Vₐₙ may be a vector, matrix, or tensor. In the exemplary embodiment, the plurality of first visual features Vₐ₁ to Vₐₙ may respectively correspond to the plurality of different time points or time periods. In the exemplary embodiment, the first visual features Vₐ₁ to Vₐₙ may correspond to respective frames (i.e., time points). In another exemplary embodiment, the first visual features Vₐ₁ to Vₐₙ may respectively correspond to a plurality of consecutive frames (i.e., time periods). In a yet another exemplary embodiment, at least one or more of the plurality of first visual features Vₐ₁ to Vₐₙ may correspond to respective frames (i.e., time points), and the remainders of the plurality of first visual features Vₐ₁ to Vₐₙ may respectively correspond to a plurality of consecutive frames (i.e., time periods).

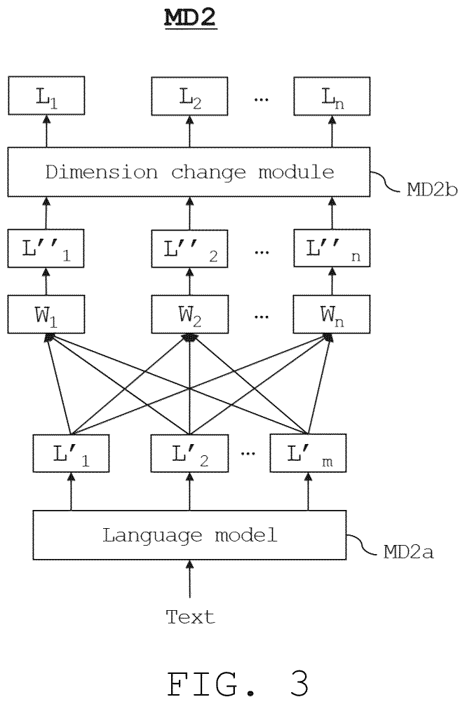

The multimodal temporal-axis fusion artificial intelligence model MD may further include a text feature extraction module MD2 for obtaining a plurality of text features L₁ to Lₙ respectively corresponding to the plurality of different time points or time periods from text. In the exemplary embodiment, the text feature extraction module MD2 may include a text feature extraction module MD2 as shown in FIG. 3. The processor 120 may obtain the plurality of text features L₁ to Lₙ respectively corresponding to the plurality of different time points or time periods from the text by using the text feature extraction module MD2.

In the exemplary embodiment, the text may include at least one of subtitles of the video, a comment of the video, a title of the video, a description of the video, and a classification standard of the video.

In the exemplary embodiment, each of the text features L₁ to Lₙ may be a vector, matrix, or tensor. In the exemplary embodiment, a dimension of each of the text features L₁ to Lₙ may be the same as a dimension of each of the first visual features Vₐ₁ to Vₐₙ. That is, the number of real numbers constituting each of the text features L₁ to Lₙ may be the same as the number of real numbers constituting each of the first visual features Vₐ₁ to Vₐₙ.

In the exemplary embodiment, the plurality of text features L₁ to Lₙ may respectively correspond to the plurality of different time points or time periods. In the exemplary embodiment, the text features L₁ to Lₙ may correspond to respective frames (i.e., time points). In another exemplary embodiment, the text features L₁ to Lₙ may respectively correspond to a plurality of consecutive frames (i.e., time periods). In a yet another exemplary embodiment, at least one or more of the plurality of text features L₁ to Lₙ may correspond to respective frames (i.e., time points), and the remainders of the plurality of text features L₁ to Lₙ may respectively correspond to a plurality of consecutive frames (i.e., time periods).

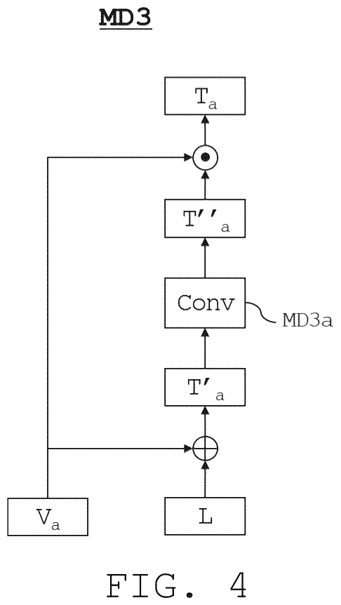

The multimodal temporal-axis fusion artificial intelligence model MD may further include a first local fusion module MD3 for obtaining a plurality of first local fusion features Tₐ₁ to Tₐₙ, respectively corresponding to the plurality of different time points or time periods, from the plurality of first visual features Vₐ₁ to Vₐₙ and the plurality of text features L₁ to Lₙ by fusing the first visual features and the text features, which correspond to the same time point or time period. In the exemplary embodiment, the first local fusion module MD3 may include a first local fusion module MD3 as shown in FIG. 4. The processor 120 may obtain the plurality of first local fusion features Tₐ₁ to Tₐₙ respectively corresponding to the plurality of different time points or time periods from the plurality of first visual features Vₐ₁ to Vₐₙ and the plurality of text features L₁ to Lₙ by using the first local fusion module MD3 to fuse the first visual features and the text features, which correspond to the same time point or time period. For example, the processor 120 may obtain a first local fusion feature Tₐ₁ corresponding to a first time point by fusing a first visual feature Vₐ₁ corresponding to the first time point and a text feature L₁ corresponding to the first time point.

In the exemplary embodiment, each of the first local fusion features Tₐ₁ to Tₐₙ may be a vector, matrix, or tensor. In the exemplary embodiment, the plurality of local fusion features Tₐ₁ to Tₐₙ may respectively correspond to the plurality of different time points or time periods. In the exemplary embodiment, the first local fusion features Tₐ₁ to Tₐₙ may correspond to respective frames (i.e., time points). In another exemplary embodiment, the first local fusion features Tₐ₁ to Tₐₙ may respectively correspond to a plurality of consecutive frames (i.e., time periods). In a yet another exemplary embodiment, at least one or more of the plurality of first local fusion features Tₐ₁ to Tₐₙ may correspond to respective frames (i.e., time points), and the remainders of the plurality of first local fusion features Tₐ₁ to Tₐₙ may respectively correspond to a plurality of consecutive frames (i.e., time periods).

The multimodal temporal-axis fusion artificial intelligence model MD may further include a global fusion module MD4 for obtaining at least one global fusion feature, e.g., a plurality of global fusion features G₁ to Gₙ, from the plurality of first local fusion features Tₐ₁ to Tₐₙ. The processor 120 may obtain the at least one global fusion feature, e.g., the plurality of global fusion features G₁ to Gₙ, from the plurality of first local fusion features Tₐ₁ to Tₐₙ by using the global fusion module MD4.

In the exemplary embodiment, the global fusion module MD4 may include a self-attention layer. The processor 120 may obtain the at least one global fusion feature, e.g., the plurality of global fusion features G₁ to Gₙ, from the plurality of first local fusion features Tₐ₁ to Tₐₙ by using self-attention. The self-attention may be at least one of narrow self-attention (Vaswani et al., Attention is All you Need, NIPS 2017) and modified self-attention. The narrow self-attention may include multi-head self-attention. For example, the global fusion module MD4 may include at least one of a narrow transformer (Vaswani et al., Attention is All you Need, NIPS 2017 or An Image is Worth 16×16 Words: Transformers for Image Recognition at Scale, ICLR 2021) and a modified transformer. For example, the modified transformer may include at least one of a Swin transformer (Liu et al., Swin Transformer: Hierarchical Vision Transformer using Shifted Windows, ICCV 2021), a Reformer (Kitaev et al., Reformer: The efficient transformer, ICLR 2020), a Linformer (Wang et al., Linformer: Self-attention with linear complexity, arXiv 2020), a Performer (Choromanski et al., Rethinking attention with performers, ICLR 2020), and a Longformer (Beltagy et al., Longformer: The long-document transformer, arXiv 2020).

In the exemplary embodiment, each of the global fusion features G₁ to Gₙ may be a vector, matrix, or tensor. In the exemplary embodiment, the plurality of global fusion features G₁ to Gₙ may respectively correspond to the plurality of different time points or time periods. In the exemplary embodiment, the global fusion features G₁ to Gₙ may correspond to respective frames (i.e., time points). In another exemplary embodiment, the global fusion features G₁ to Gₙ may respectively correspond to a plurality of consecutive frames (i.e., time periods). In a yet another exemplary embodiment, at least one or more of the plurality of global fusion features G₁ to Gₙ may correspond to respective frames (i.e., time points), and the remainders of the plurality of global fusion features G₁ to Gₙ may respectively correspond to a plurality of consecutive frames (i.e., time periods).

FIG. 3 is a conceptual diagram illustrating a text feature extraction module used in the electronic device according to the exemplary embodiments of the present disclosure. Referring to FIG. 3, the text feature extraction module MD2 may include a plurality of mapping layers W₁ to Wₙ respectively corresponding to the plurality of different time points or time periods. The processor 120 may obtain the plurality of text features L₁ to Lₙ respectively corresponding to the plurality of different time points or time periods from the text by using the plurality of mapping layers W₁ to Wₙ respectively corresponding to the plurality of different time points or time periods. In the exemplary embodiment, the plurality of mapping layers may include a plurality of different matrices. The processor 120 may obtain the text features L₁ to Lₙ different for each time point or time period by using the mapping layers W₁ to Wₙ different for each time point or time period.

In the exemplary embodiment, the text feature extraction module MD2 may include a language model MD2a for obtaining a plurality of first intermediate text features L′₁ to L′ₘ from the text. The processor 120 may obtain the plurality of first intermediate text features L′₁ to L′ₘ from the text by using the language model MD2a. In the exemplary embodiment, the plurality of first intermediate text features L′₁ to L′ₘ may correspond to respective tokens of the text. In the exemplary embodiment, each of the first intermediate text features L′₁ to L′ₘ may be a vector, matrix, or tensor.

In the exemplary embodiment, the language model MD2a may include at least one of a recurrent neural network (RNN)-based language model and a transformer-based language model. The recurrent neural network-based language model may include at least one of a narrow RNN, a Long Short-Term Memory (LSTM), a Gated Recurrent Unit (GRU), and a Bidirectional-RNN (Bi-RNN). The transformer-based language model may include, for example, at least one of a BERT (Devlin et al., BERT: Pre-training of Deep Bidirectional Transformer for Language Understanding, A C L 2019), and a RoBERTa (Liu et al., RoBERTa: A Robustly Optimized BERT Pretraining Approach, ICLR 2020).

In the exemplary embodiment, the text feature extraction module MD2 may include the plurality of mapping layers W₁ to Wₙ for obtaining a plurality of second intermediate text features L″₁ to L″ₙ respectively corresponding to the plurality of different time points or time periods from the plurality of first intermediate text features L′₁ to L′ₘ. The mapping layers W₁ to Wₙ may correspond to respective time points or time periods. The processor 120 may obtain the plurality of second intermediate text features L″₁ to L″ₙ respectively corresponding to the plurality of different time points or time periods from the plurality of first intermediate text features L′₁ to L′ₘ by using the plurality of mapping layers W₁ to Wₙ respectively correspond to the plurality of different time points or time periods. For example, by using a mapping layer W₁ corresponding to a first time point, the processor 120 may obtain a second intermediate text feature L″₁ corresponding to the first time point from the plurality of first intermediate text features L′₁ to L′ₘ respectively corresponding to a plurality of tokens of the text. In the exemplary embodiment, the number m of the first intermediate text features L′₁ to L′ₘ may be different from the number n of the second intermediate text features L″₁ to L″ₙ.

In the exemplary embodiment, each of the second intermediate text features L″₁ to L″ₙ may be a vector, matrix, or tensor. In the exemplary embodiment, the plurality of second intermediate text features L″₁ to L″ₙ may respectively correspond to the plurality of different time points or time periods. In the exemplary embodiment, the second intermediate text features L″₁ to L″ₙ may correspond to respective frames (i.e., time points). In another exemplary embodiment, the second intermediate text features L″₁ to L″ₙ may respectively correspond to a plurality of consecutive frames (i.e., time periods). In a yet another exemplary embodiment, at least one or more of the plurality of second intermediate text features L″₁ to L″ₙ may correspond to respective frames (i.e., time points), and the remainders of the plurality of second intermediate text features L″₁ to L″ₙ may respectively correspond to a plurality of consecutive frames (i.e., time periods).

In the exemplary embodiment, the text feature extraction module MD2 may include a dimension change module MD2b for obtaining the plurality of text features L₁ to Lₙ from the plurality of second intermediate text features L″₁ to L″ₙ by changing dimensions of the second intermediate text features L″₁ to L″ₙ. The processor 120 may obtain the plurality of text features L₁ to Lₙ from the plurality of second intermediate text features L″₁ to L″ₙ by using the dimension change module MD2b to change the dimensions of the second intermediate text features L″₁ to L″ₙ. For example, the processor 120 may obtain a text feature L₁ corresponding to a first time point from a second intermediate text feature L″₁ corresponding to the first time point by using the dimension change module MD2b. The number of real numbers constituting each of the second intermediate text features L″₁ to L″ₙ and the number of real numbers constituting each of the text features L₁ to Lₙ may be different from each other. In the exemplary embodiment, the dimensions of the text features L₁ to Lₙ may respectively be the same as the dimensions of the first visual features Vₐ₁ to Vₐₙ (see FIG. 2). That is, the number of real numbers constituting each of the text features L₁ to Lₙ may be the same as the number of real numbers constituting each of the first visual features Vₐ₁ to Vₐₙ (see FIG. 2).

FIG. 4 is a conceptual diagram illustrating a first local fusion module used in the electronic device according to the exemplary embodiments of the present disclosure. Referring to FIG. 4, the first local fusion module MD3 may include a convolutional network MD3a. In the exemplary embodiment, the convolutional network MD3a may include a pooling layer, a 1×1 convolutional layer, and an activation layer. For example, the pooling layer may include at least one of a channel-wise average layer, a channel maximum (max) layer, and a channel minimum (min) layer. For example, the activation layer may include a sigmoid layer, a ReLU layer, or a tanh layer. The processor 120 may obtain a first local fusion feature Tₐ from a first visual feature Vₐ and a text feature L by using convolution.

In the exemplary embodiment, the processor 120 may obtain a first intermediate local fusion feature T′ₐ from the first visual feature Vₐ and the text feature L. In the exemplary embodiment, the first intermediate local fusion feature T′ₐ may be a vector, matrix, or tensor. For example, the processor 120 may obtain the first intermediate local fusion feature T′ₐ by obtaining the sum of the first visual feature Vₐ and the text feature L.

In the exemplary embodiment, the processor 120 may obtain a second intermediate local fusion feature T″ₐ from the first intermediate local fusion feature T′ₐ by using the convolutional network MD3a. In the exemplary embodiment, the second intermediate local fusion feature T″ₐ may be a vector, matrix, or tensor.

In the exemplary embodiment, the processor 120 may obtain the first local fusion feature Tₐ from the first visual feature Vₐ and the second intermediate local fusion feature T″ₐ. For example, the processor 120 may obtain the first local fusion feature Tₐ by obtaining a value calculated by taking a dot product of the first visual feature Vₐ and the second intermediate local fusion feature T″ₐ.

FIG. 5 is a conceptual diagram illustrating a first visual feature extraction module used in the electronic device according to the exemplary embodiments of the present disclosure. Referring to FIG. 5, the first visual feature extraction module MD1a may include an object feature extraction module MD1a-1 for obtaining a plurality of object features O₁ to Oₙ from the video. The processor 120 may obtain the plurality of object features O₁ to Oₙ from the video by using the object feature extraction module MD1a-1. For example, the object feature extraction module MD1a-1 may include at least one of a Faster-RCNN (Ren et al., Faster R-CNN: Towards Real-Time Object Detection with Region Proposal Networks, NIPS 2015) and a YOLO (Redmon et al., You Only Look Once: Unified, Real-Time Object Detection, CVPR 2016).

In the exemplary embodiment, each of the plurality of object features O₁ to Oₙ may be a vector, matrix, or tensor. In the exemplary embodiment, the plurality of object features O₁ to Oₙ may respectively correspond to the plurality of different time points or time periods. In the exemplary embodiment, the object features O₁ to Oₙ may correspond to respective frames (i.e., time points). In another exemplary embodiment, the object features O₁ to Oₙ may respectively correspond to a plurality of consecutive frames (i.e., time periods). In a yet another exemplary embodiment, at least one or more of the plurality of object features O₁ to Oₙ may correspond to respective frames (i.e., time points), and the remainders of the plurality of object features O₁ to Oₙ may respectively correspond to a plurality of consecutive frames (i.e., time periods).

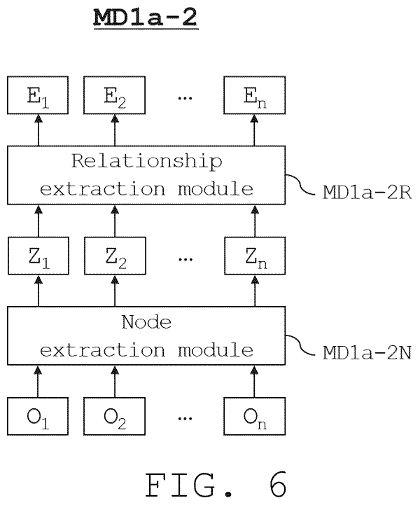

In the exemplary embodiment, the first visual feature extraction module MD1a may include an object graph extraction module MD1a-2 for obtaining a plurality of object graphs E₁ to Eₙ from the plurality of object features O₁ to Oₙ. For example, the object graph extraction module MD1a-2 may include an object graph extraction module MD1a-2 shown in FIG. 6. The processor 120 may obtain the plurality of object graphs E₁ to Eₙ from the plurality of object features O₁ to Oₙ by using the object graph extraction module MD1a-2. In the exemplary embodiment, the processor 120 may obtain the plurality of object graphs E₁ to Eₙ corresponding to respective time points or time periods from the object features O₁ to Oₙ corresponding to the respective time points or time periods by using the object graph extraction module MD1a-2. For example, the processor 120 may obtain an object graph E₁ corresponding to a first time point from an object feature O₁ corresponding to the first time point by using the object graph extraction module MD1a-2.

In the exemplary embodiment, the plurality of object graphs E₁ to Eₙ may respectively correspond to the plurality of different time points or time periods. In the exemplary embodiment, the object graphs E₁ to Eₙ may correspond to respective frames (i.e., time points). In another exemplary embodiment, object graphs E₁ to Eₙ may respectively correspond to a plurality of consecutive frames (i.e., time periods). In a yet another exemplary embodiment, at least one or more of the plurality of object graphs E₁ to Eₙ may correspond to respective frames (i.e., time points), and the remainders of the plurality of object graphs E₁ to Eₙ may respectively correspond to a plurality of consecutive frames (i.e., time periods).

In the exemplary embodiment, the first visual feature extraction module MD1a may include an object graph feature extraction module MD1a-3 for obtaining the plurality of first visual features Vₐ₁ to Vₐₙ from the plurality of object graphs E₁ to Eₙ. The processor 120 may obtain the plurality of first visual features Vₐ₁ to Vₐₙ from the plurality of object graphs E₁ to Eₙ by using the object graph feature extraction module MD1a-3. For example, the object graph feature extraction module MD1a-3 may include a graph convolution layer. In the exemplary embodiment, the processor 120 may obtain the plurality of first visual features Vₐ₁ to Vₐₙ corresponding to respective time points or time periods from the object graphs E₁ to Eₙ corresponding to the respective time points or time periods by using the object graph feature extraction module MD1a-3. For example, the processor 120 may obtain a first visual feature Vₐ₁ corresponding to a first time point from an object graph E₁ corresponding to the first time point by using the object graph feature extraction module MD1a-3.

FIG. 6 is a conceptual diagram illustrating an object graph extraction module used in the electronic device according to the exemplary embodiments of the present disclosure. Referring to FIG. 6, the object graph extraction module MD1a-2 may include a node extraction module MD1a-2N for obtaining a plurality of object graph node sets Z₁ to Zₙ from the plurality of object features O₁ to Oₙ, and a relationship extraction module MD1a-2R for obtaining the plurality of object graphs E₁ to Eₙ by obtaining relationships between nodes in each of the object graph node sets Z₁ to Zₙ from the plurality of object graph node sets Z₁ to Zₙ. The processor 120 may obtain the plurality of object graph node sets Z₁ to Zₙ from the plurality of object features O₁ to Oₙ by using the node extraction module MD1a-2N, and may obtain the plurality of object graphs E₁ to Eₙ by obtaining the relationships between the nodes in each of the object graph node sets Z₁ to Zₙ from the plurality of object graph node sets Z₁ to Zₙ by using the relationship extraction module MD1a-2R.

In the exemplary embodiment, the node extraction module MD1a-2N may include at least one of a transformer-based model and a convolutional network-based model. In the exemplary embodiment, the relationship extraction module MD1a-2R may include at least one of a transformer-based model and a convolutional network-based model.

In the exemplary embodiment, the processor 120 may obtain the object graph node sets Z₁ to Zₙ corresponding to respective time points or time periods from the object features O₁ to Oₙ corresponding to the respective time points or time periods by using the node extraction module MD1a-2N. For example, the processor 120 may obtain an object graph node set Z₁ corresponding to a first time point from an object feature O₁ corresponding to the first time point by using the node extraction module MD1a-2N.

In the exemplary embodiment, the processor 120 may obtain the relationships between the nodes in the object graph node sets Z₁ to Zₙ corresponding to the respective time points or time periods from the object graph node sets Z₁ to Zₙ corresponding to the respective time points or time periods by using the relationship extraction module MD1a-2R, so as to obtain the object graphs E₁ to Eₙ corresponding to the respective time points or time periods. For example, the processor 120 may obtain relationships between nodes in an object graph node set Z₁ corresponding to a first time point from an object graph node set Z₁ corresponding to the first time point by using the relationship extraction modules MD1a-2R, so as to obtain an object graph E₁ corresponding to the first time point.

FIG. 7 is a conceptual diagram illustrating a multimodal temporal-axis fusion artificial intelligence model according to exemplary embodiments of the present disclosure. Hereinafter, focusing on differences between the multimodal temporal-axis fusion artificial intelligence model MD shown in FIG. 2 and the multimodal temporal-axis fusion artificial intelligence model MD′ shown in FIG. 7, the multimodal temporal-axis fusion artificial intelligence model MD′ shown in FIG. 7 is described.

Referring to FIG. 7, the multimodal temporal-axis fusion artificial intelligence model MD′ may further include: a second visual feature extraction module MD1b for obtaining a plurality of second visual features V_{b1} to V_{bn} respectively corresponding to the plurality of different time points or time periods from the video; and a second local fusion module MD6 for obtaining a plurality of second local fusion features T_{b1} to T_{bn}, respectively corresponding to the plurality of time points or time periods, from the plurality of second visual features V_{b1} to V_{bn} and the plurality of text features L₁ to Lₙ by fusing the second visual features and the text features, which correspond to the same time point or time period. The processor 120 may obtain the plurality of second visual features V_{b1} to V_{bn} respectively corresponding to the plurality of time points or time periods from the video by using the second visual feature extraction module MD1b, and fuse the second visual features and the text features, which correspond to the same time point or time period, by using the second local fusion module MD6, so as to obtain the plurality of second local fusion features T_{b1} to T_{bn} respectively corresponding to the plurality of time points or time periods from the plurality of second visual features V_{b1} to V_{bn} and the plurality of text features L₁ to Lₙ.

The plurality of first visual features Vₐ₁ to Vₐₙ (see FIG. 2) and the plurality of second visual features V_{b1} to V_{bn} may be different from each other. For example, as described with reference to FIG. 5, the plurality of first visual features Vₐ₁ to Vₐₙ may be object graph-based visual features and the plurality of second visual features V_{b1} to V_{bn} may be appearance-based visual features. For example, the first visual feature extraction module MD1a may include a Faster-RCNN, and the second visual feature extraction module MD1b may include an ResNet. In the exemplary embodiment, the second local fusion feature module MD6 may have the same structure as that of the first local fusion module MD3, but may have different parameters. In another exemplary embodiment, the second local fusion feature module MD6 may have a different structure from that of the first local fusion module MD3.

The processor 120 may obtain a plurality of third local fusion features T_{c1} to T_{cn} from the plurality of first local fusion features Tₐ₁ to Tₐₙ and the plurality of second local fusion features T_{b1} to T_{bn}. The third local fusion features T_{c1} to T_{cn} may correspond to respective time points or time periods. For example, the processor 120 may obtain the third local fusion features corresponding to the same time point or time period by concatenating, adding, or multiplying the first local fusion features and the second local fusion features, which correspond to the same time point or time period. For example, the processor 120 may obtain a third local fusion feature T_{c1} corresponding to a first time point by concatenating, adding, or multiplying a first local fusion feature Tₐ₁ and a second local fusion feature T_{b1}, which correspond to the first time point.

A global fusion module MD4′ may obtain the at least one global fusion feature, e.g., the plurality of global fusion features G₁ to Gₙ, from the plurality of third local fusion features T_{c1} to T_{cn}. The processor 120 may obtain the at least one global fusion feature, e.g., the plurality of global fusion features G₁ to Gₙ from the plurality of third local fusion features T_{c1} to T_{cn} by using the global fusion module MD4′. As described with reference to FIG. 2, the global fusion module MD4′ may include a self-attention layer.

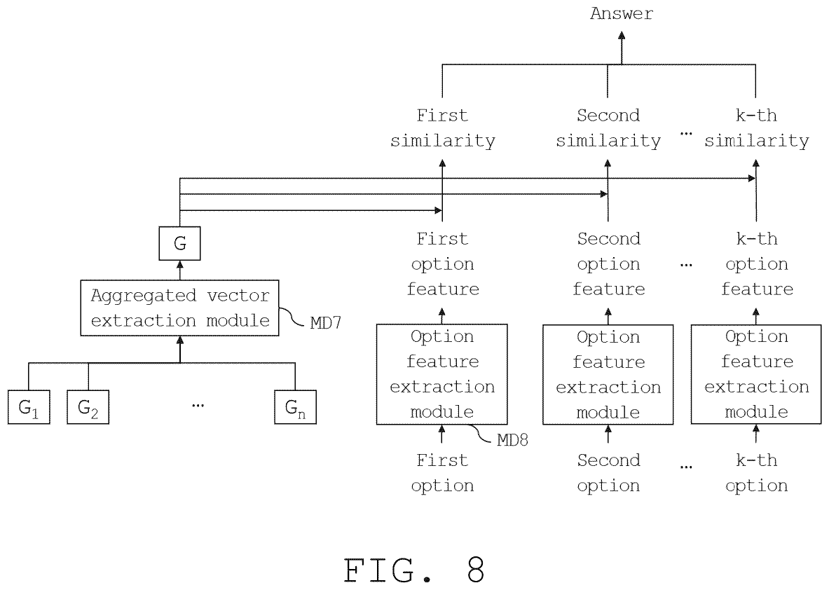

FIG. 8 is a conceptual diagram illustrating the multimodal temporal-axis fusion artificial intelligence models according to the exemplary embodiments of the present disclosure. Referring to FIG. 8, the multimodal temporal-axis fusion artificial intelligence models MD and MD′ may obtain an answer to a question by using the at least one global fusion feature, e.g., the plurality of global fusion features G₁ to Gₙ. The text may contain the question.

The multimodal temporal-axis fusion artificial intelligence models MD and MD′ may include an aggregated vector extraction module MD7 for obtaining an aggregated vector G from the at least one global fusion feature, e.g., the plurality of global fusion features G₁ to Gₙ. The processor 120 may obtain the aggregated vector G from the at least one global fusion feature, e.g., the plurality of global fusion features G₁ to Gₙ by using the aggregated vector extraction module MD7.

Each of the multimodal temporal-axis fusion artificial intelligence models MD and MD′ may include an option feature extraction module MD8 for obtaining a plurality of option features respectively from a plurality of options. The processor 120 may obtain the plurality of option features respectively from the plurality of options by using the option feature extraction module MD8. In the exemplary embodiment, the option feature extraction module MD8 may include at least one of a BERT and an RoBERTa. In the exemplary embodiment, each of the option features may be a vector, matrix, or tensor.

The processor 120 may obtain the answer to the question expressed in text from the aggregated vector G and each option feature. For example, the processor 120 may obtain a similarity between the aggregated vector G and each option feature, and select an option having the highest similarity to the aggregated vector G as the answer. For example, the processor 120 may obtain a cosine similarity between the aggregated vector G and each option feature or a distance between the aggregated vector G and each option feature in order to obtain the similarity between the aggregated vector G and each option feature.

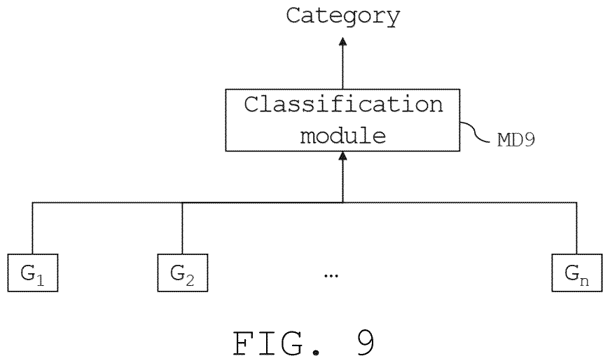

FIG. 9 is a conceptual diagram illustrating the multimodal temporal-axis fusion artificial intelligence models according to the exemplary embodiments of the present disclosure. Referring to FIG. 9, each of the multimodal temporal-axis fusion artificial intelligence models MD and MD′ may further include a classification module MD9 for classifying a video by using the at least one global fusion feature, e.g., the plurality of global fusion features G₁ to Gₙ. The processor 120 may classify the video by using the classification module MD9 and the at least one global fusion feature, e.g., the plurality of global fusion features G₁ to Gₙ. In the exemplary embodiment, the processor 120 may classify the video by religion or political orientation. In the exemplary embodiment, the processor 120 may classify the video according to whether it is adult material or not, whether it is hate material or not, whether it is related to a specific issue or not, whether it is related to a specific brand or not, etc.

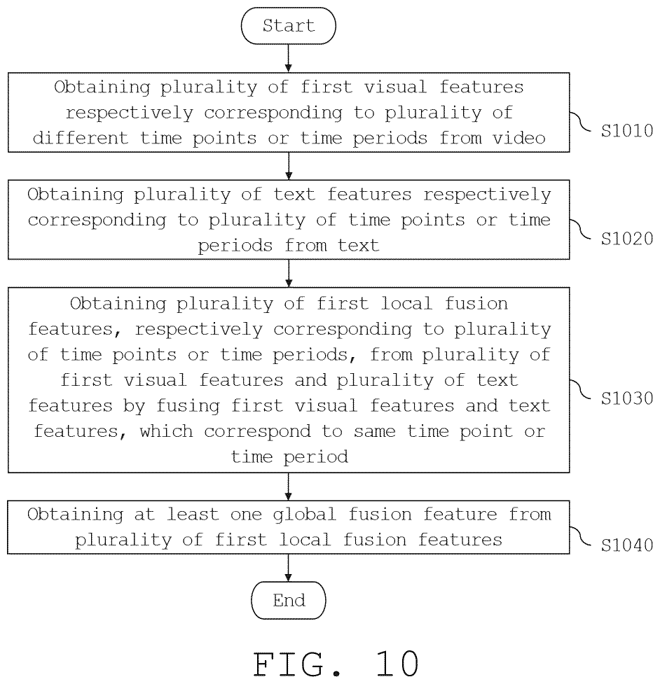

FIG. 10 is a flowchart illustrating an operation method of an electronic device according to the exemplary embodiments of the present disclosure. Referring to FIG. 10, the operation method of the electronic device may include: step S1010 of obtaining a plurality of first visual features respectively corresponding to a plurality of different time points or time periods from a video; step S1020 of obtaining a plurality of text features respectively corresponding to the plurality of time points or time periods from text; step S1030 of obtaining a plurality of first local fusion features, respectively corresponding to the plurality of time points or time periods, from the plurality of first visual features and the plurality of text features by fusing the first visual features and the text features, which correspond to the same time point or time period; and step S1040 of obtaining at least one global fusion feature from the plurality of first local fusion features.

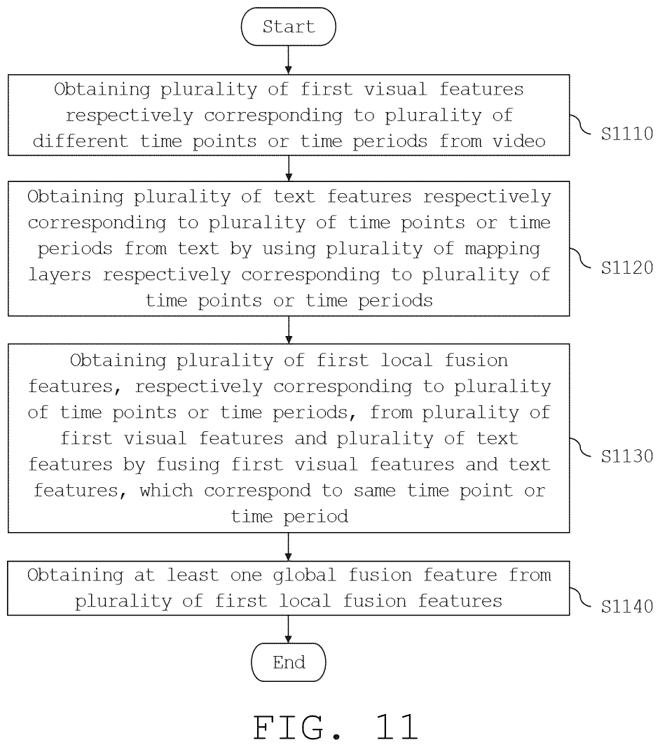

FIG. 11 is a flowchart illustrating the operation method of the electronic device according to the exemplary embodiments of the present disclosure. Referring to FIG. 11, the step S1020 of obtaining the plurality of text features (see FIG. 10) may include step S1120 of obtaining the plurality of text features respectively corresponding to the plurality of time points or time periods from the text by using a plurality of mapping layers respectively corresponding to the plurality of time points or time periods. Specifically, the operation method of the electronic device may include: step S1110 of obtaining a plurality of first visual features respectively corresponding to a plurality of different time points or time periods from a video; step S1120 of obtaining a plurality of text features respectively corresponding to the plurality of time points or time periods from text by using a plurality of mapping layers respectively corresponding to the plurality of time points or time periods; step S1130 of obtaining a plurality of first local fusion features, respectively corresponding to the plurality of time points or time periods, from the plurality of first visual features and the plurality of text features by fusing the first visual features and the text features, which correspond to the same time point or time period; and step S1140 of obtaining at least one global fusion feature from the plurality of first local fusion features.

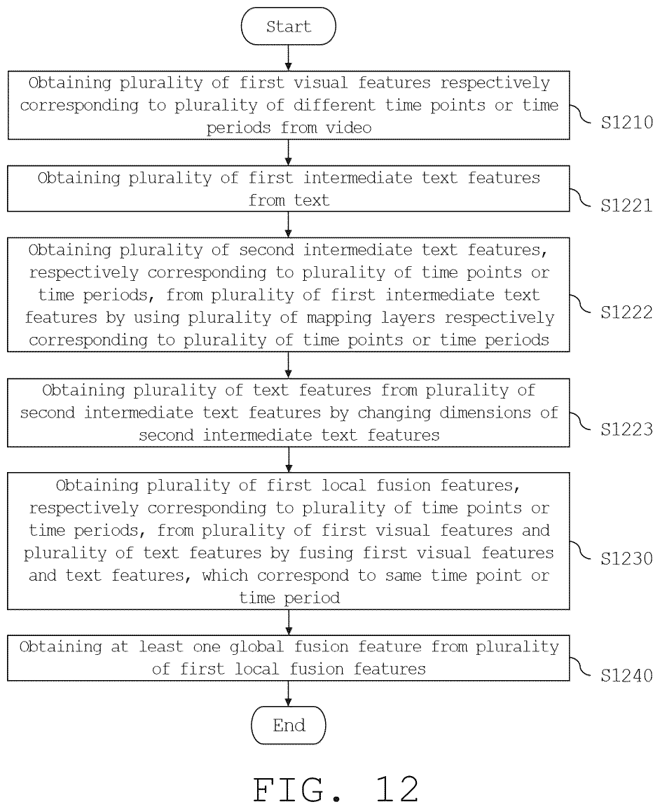

FIG. 12 is a flowchart illustrating the operation method of the electronic device according to the exemplary embodiments of the present disclosure. Referring to FIG. 12, the step S1020 of obtaining the plurality of text features (see FIG. 10) may include: step S1221 of obtaining a plurality of first intermediate text features from the text; step S1222 of obtaining a plurality of second intermediate text features respectively corresponding to the plurality of time points or time periods from the plurality of first intermediate text features by using a plurality of mapping layers respectively corresponding to the plurality of time points or time periods; and step S1223 of obtaining the plurality of text features from the plurality of second intermediate text features by changing dimensions of the second intermediate text features. In the exemplary embodiment, the number of the plurality of first intermediate text features may be different from the number of the plurality of second intermediate text features. In the exemplary embodiment, a dimension of each of the plurality of text features may be the same as a dimension of each of the plurality of first visual features.

Specifically, the operation method of the electronic device may include: step S1210 of obtaining a plurality of first visual features respectively corresponding to a plurality of different time points or time periods from a video; step S1221 of obtaining a plurality of first intermediate text features from text; step S1222 of obtaining a plurality of second intermediate text features, respectively corresponding to the plurality of time points or time periods, from the plurality of first intermediate text features by using a plurality of mapping layers respectively corresponding to the plurality of time points or time periods; step S1223 of obtaining a plurality of text features from the plurality of second intermediate text features by changing dimensions of the second intermediate text features; step S1230 of obtaining a plurality of first local fusion features, respectively corresponding to the plurality of time points or time periods, from the plurality of first visual features and the plurality of text features by fusing the first visual features and the text features, which correspond to the same time point or time period; and step S1240 of obtaining at least one global fusion feature from the plurality of first local fusion features.

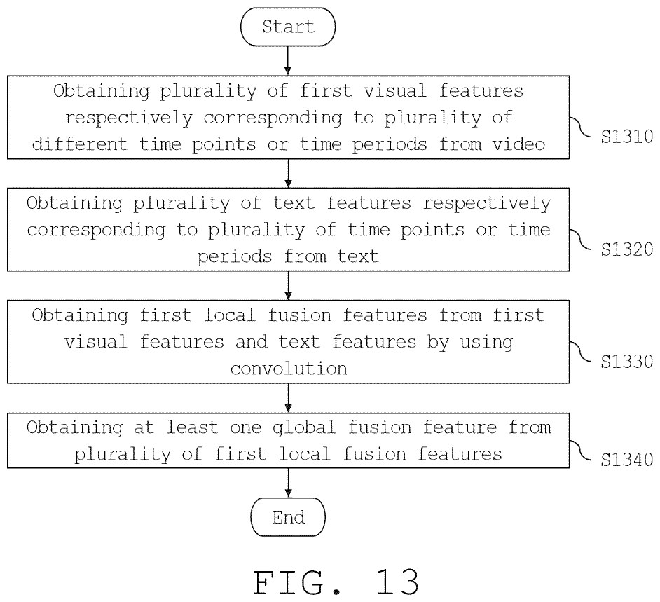

FIG. 13 is a flowchart illustrating the operation method of the electronic device according to the exemplary embodiments of the present disclosure. Referring to FIG. 13, the step S1030 of obtaining the plurality of first local fusion features (see FIG. 10) may include step S1330 of obtaining the first local fusion features from the first visual features and the text features by using convolution. Specifically, the operation method of the electronic device may include: step S1310 of obtaining a plurality of first visual features respectively corresponding to a plurality of different time points or time periods from a video; step S1320 of obtaining a plurality of text features respectively corresponding to the plurality of time points or time periods from text; step S1330 of obtaining first local fusion features from the first visual features and the text features by using convolution; and step S1340 of obtaining at least one global fusion feature from the plurality of first local fusion features.

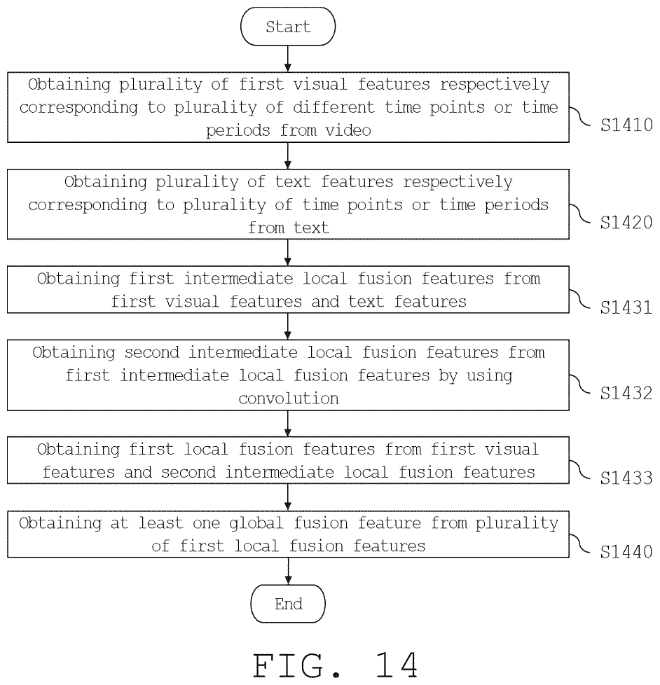

FIG. 14 is a flowchart illustrating the operation method of the electronic device according to the exemplary embodiments of the present disclosure. Referring to FIG. 14, the step S1030 of obtaining the plurality of first local fusion features (see FIG. 10) may include: step S1431 of obtaining first intermediate local fusion features from the first visual features and the text features; step S1432 of obtaining second intermediate local fusion features from the first intermediate local fusion features by using convolution; and step S1433 of obtaining the first local fusion features from the first visual features and the second intermediate local fusion features. Specifically, the operation method of the electronic device may include: step S1410 of obtaining a plurality of first visual features respectively corresponding to a plurality of different time points or time periods from a video; step S1420 of obtaining a plurality of text features respectively corresponding to the plurality of time points or time periods from text; step S1431 of obtaining first intermediate local fusion features from the first visual features and the text features; step S1432 of obtaining second intermediate local fusion features from the first intermediate local fusion features by using convolution; step S1433 of obtaining first local fusion features from the first visual features and the second intermediate local fusion features; and step S1440 of obtaining at least one global fusion feature from the plurality of first local fusion features.

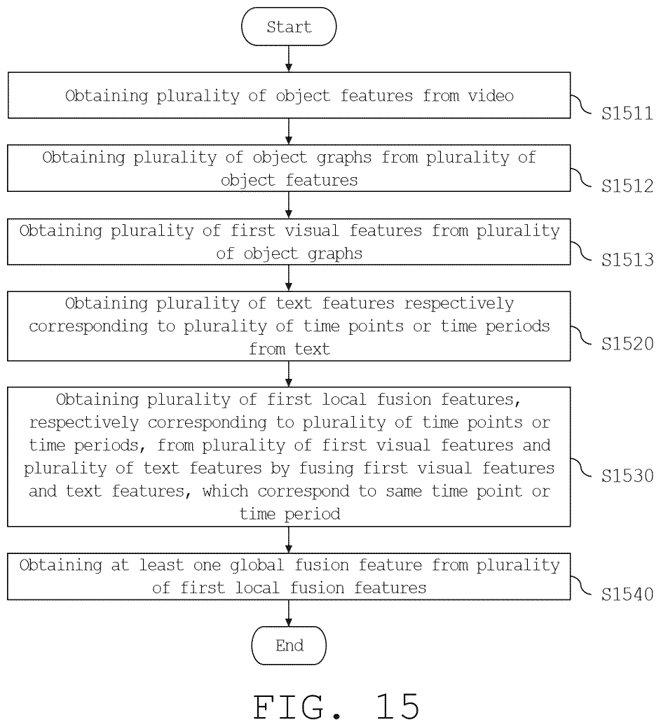

FIG. 15 is a flowchart illustrating the operation method of the electronic device according to the exemplary embodiments of the present disclosure. Referring to FIG. 15, the step S1010 of obtaining the plurality of first visual features (see FIG. 10) may include: step S1511 of obtaining a plurality of object features from a video; step S1512 of obtaining a plurality of object graphs from the plurality of object features; and step S1513 of obtaining the plurality of first visual features from the plurality of object graphs. Specifically, the operation method of the electronic device may include: step S1511 of obtaining a plurality of object features from a video; step S1512 of obtaining a plurality of object graphs from the plurality of object features; step S1513 of obtaining a plurality of first visual features from the plurality of object graphs; step S1520 of obtaining a plurality of text features respectively corresponding to a plurality of time points or time periods from text; step S1530 of obtaining a plurality of first local fusion features, respectively corresponding to the plurality of time points or time periods, from the plurality of first visual features and the plurality of text features by fusing the first visual features and the text features, which correspond to the same time point or time period; and step S1540 of obtaining at least one global fusion feature from the plurality of first local fusion features.

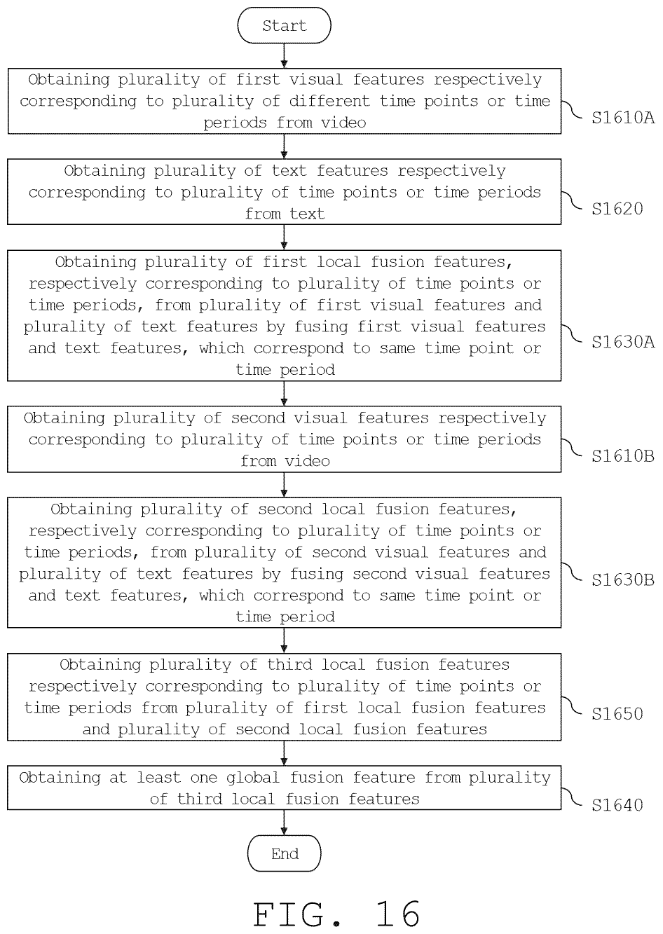

FIG. 16 is a flowchart illustrating the operation method of the electronic device according to the exemplary embodiments of the present disclosure. Referring to FIG. 16, the operation method of the electronic device may further include: step S1610B of obtaining a plurality of second visual features respectively corresponding to the plurality of time points or time periods from the video; step S1630B of obtaining a plurality of second local fusion features, respectively corresponding to the plurality of time points or time periods, from the plurality of second visual features and the plurality of text features by fusing the second visual features and the text features, which correspond to the same time point or time period; and step S1650 of obtaining a plurality of third local fusion features respectively corresponding to the plurality of time points or time periods from the plurality of first local fusion features and the plurality of second local fusion features, and the step S1040 of obtaining the at least one global fusion feature (see FIG. 10) may include step S1640 of obtaining the at least one global fusion feature from the plurality of third local fusion features.

Specifically, the operation method of the electronic device may include: step S1610A of obtaining a plurality of first visual features respectively corresponding to a plurality of different time points or time periods from a video; step S1620 of obtaining a plurality of text features respectively corresponding to the plurality of time points or time periods from text; step S1630A of obtaining a plurality of first local fusion features, respectively corresponding to the plurality of time points or time periods, from the plurality of first visual features and the plurality of text features by fusing the first visual features and the text features, which correspond to the same time point or time period; step S1610B of obtaining a plurality of second visual features respectively corresponding to the plurality of time points or time periods from the video; step S1630B of obtaining a plurality of second local fusion features, respectively corresponding to the plurality of time points or time periods, from the plurality of second visual features and the plurality of text features by fusing the second visual features and the text features, which correspond to the same time point or time period; step S1650 of obtaining a plurality of third local fusion features respectively corresponding to the plurality of time points or time periods from the plurality of first local fusion features and the plurality of second local fusion features; and step S1640 of obtaining at least one global fusion feature from the plurality of third local fusion features.

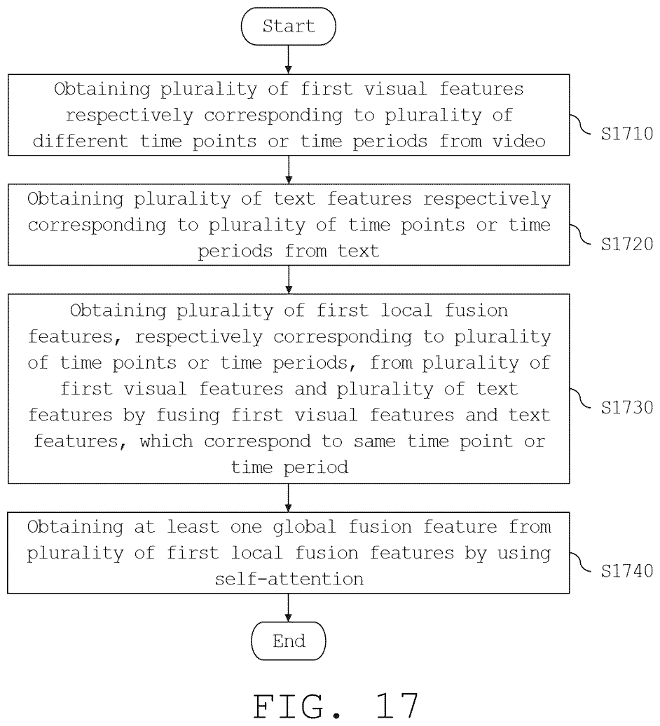

FIG. 17 is a flowchart illustrating the operation method of the electronic device according to the exemplary embodiments of the present disclosure. Referring to FIG. 17, the step S1040 of obtaining the at least one global fusion feature (see FIG. 10) may include step S1740 of obtaining the at least one global fusion feature from the plurality of first local fusion features by using self-attention. Specifically, the operation method of the electronic device may include: step S1710 of obtaining a plurality of first visual features respectively corresponding to a plurality of different time points or time periods from a video; step S1720 of obtaining a plurality of text features respectively corresponding to the plurality of time points or time periods from text; step S1730 of obtaining a plurality of first local fusion features, respectively corresponding to the plurality of time points or time periods, from the plurality of first visual features and the plurality of text features by fusing the first visual features and the text features, which correspond to the same time point or time period; and step S1740 of obtaining at least one global fusion feature from the plurality of first local fusion features by using self-attention.

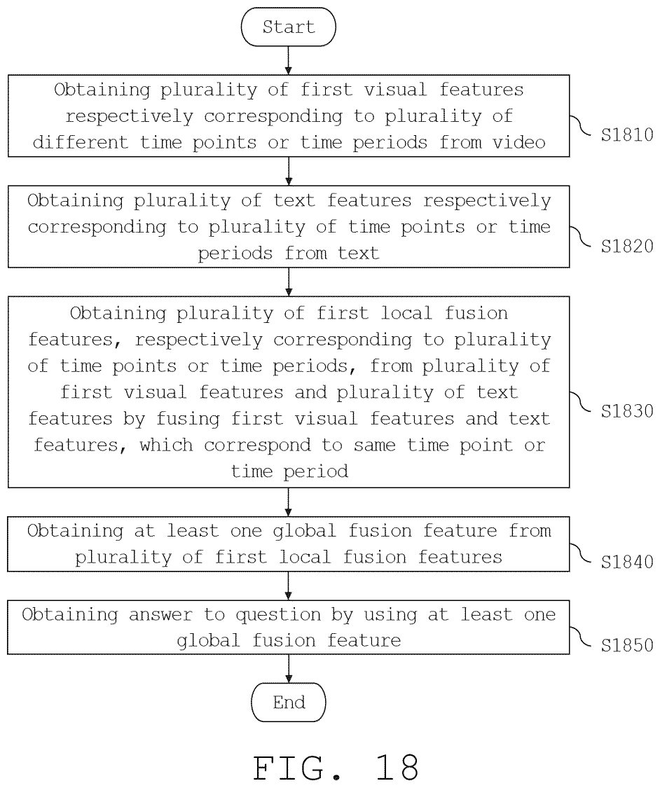

FIG. 18 is a flowchart illustrating the operation method of the electronic device according to the exemplary embodiments of the present disclosure. Text in FIG. 18 may contain a question. Referring to FIG. 18, the operation method of the electronic device may further include step S1850 of obtaining an answer to the question by using the at least one global fusion feature. Specifically, the operation method of the electronic device may include: step S1810 of obtaining a plurality of first visual features respectively corresponding to a plurality of different time points or time periods from a video; step S1820 of obtaining a plurality of text features respectively corresponding to the plurality of time points or time periods from text; step S1830 of obtaining a plurality of first local fusion features, respectively corresponding to the plurality of time points or time periods, from the plurality of first visual features and the plurality of text features by fusing the first visual features and the text features, which correspond to the same time point or time period; step S1840 of obtaining at least one global fusion feature from the plurality of first local fusion features; and step S1850 of obtaining an answer to a question by using the at least one global fusion feature.

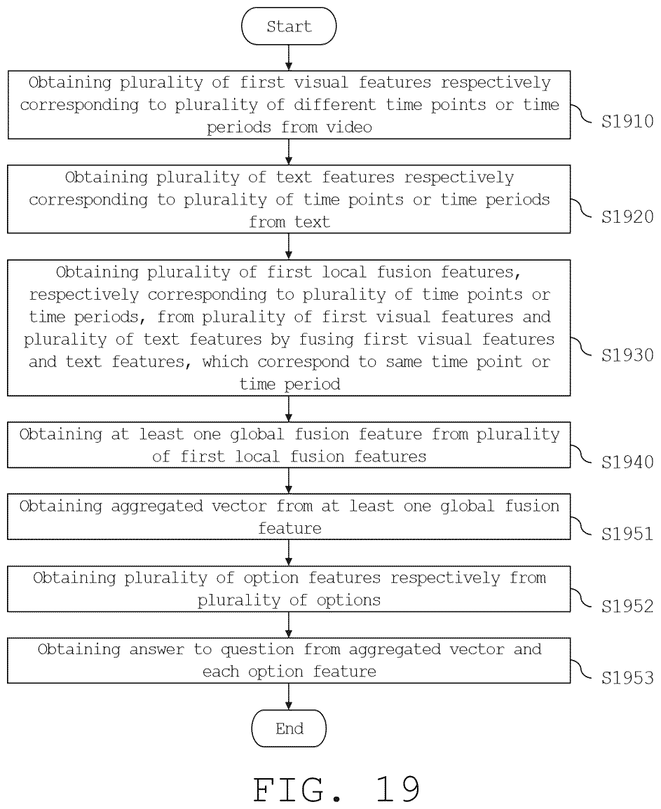

FIG. 19 is a flowchart illustrating the operation method of the electronic device according to the exemplary embodiments of the present disclosure. At least one global fusion feature in FIG. 19 may include a plurality of global fusion features. Referring to FIG. 19, the step S1850 of obtaining the answer to the question (see FIG. 18) may include: step S1951 of obtaining an aggregated vector from the at least one global fusion feature; step S1952 of obtaining a plurality of option features respectively from a plurality of options; and step S1953 of obtaining the answer to the question from the aggregated vector and each option feature. Specifically, the operation method of the electronic device may include: step S1910 of obtaining a plurality of first visual features respectively corresponding to a plurality of different time points or time periods from a video; step S1920 of obtaining a plurality of text features respectively corresponding to the plurality of time points or time periods from text; step S1930 of obtaining a plurality of first local fusion features, respectively corresponding to the plurality of time points or time periods, from the plurality of first visual features and the plurality of text features by fusing the first visual features and the text features, which correspond to the same time point or time period; step S1940 of obtaining at least one global fusion feature from the plurality of first local fusion features; step S1951 of obtaining an aggregated vector from the at least one global fusion feature; step S1952 of obtaining a plurality of option features respectively from a plurality of options; and step S1953 of obtaining an answer to a question from the aggregated vector and each option feature.

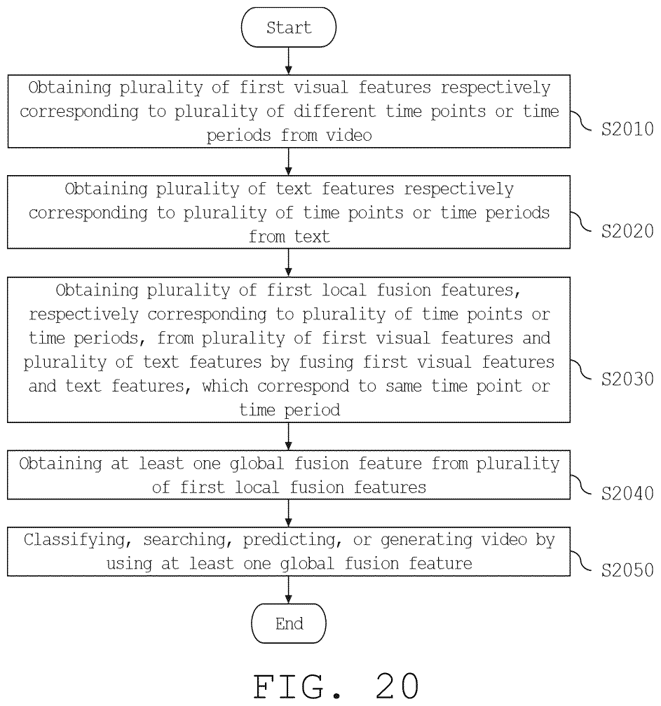

FIG. 20 is a flowchart illustrating the operation method of the electronic device according to the exemplary embodiments of the present disclosure. Referring to FIG. 20, the operation method of the electronic device may further include step S2050 of classifying, searching, predicting, or generating the video by using the at least one global fusion feature. Specifically, the operation method of the electronic device may include: step S2010 of obtaining a plurality of first visual features respectively corresponding to a plurality of different time points or time periods from a video; step S2020 of obtaining a plurality of text features respectively corresponding to the plurality of time points or time periods from text; step S2030 of obtaining a plurality of first local fusion features, respectively corresponding to the plurality of time points or time periods, from the plurality of first visual features and the plurality of text features by fusing the first visual features and the text features, which correspond to the same time point or time period; step S2040 of obtaining at least one global fusion feature from the plurality of first local fusion features; and step S2050 of classifying, searching, predicting, or generating the video by using the at least one global fusion feature.

### Exemplary Embodiments and Comparative Examples

First exemplary embodiment: as shown in FIG. 7, object graph-based first visual features and appearance-based second visual features are used.

Second exemplary embodiment: as shown in FIG. 2, object graph-based visual features are used as first visual features, and appearance-based visual features are not used.

Third exemplary embodiment: as shown in FIG. 2, appearance-based visual features are used as first visual features, and object graph-based visual features are not used.

Fourth exemplary embodiment: motion-based third visual features are additionally used along with object graph-based first visual features and appearance-based second visual features.

Fifth exemplary embodiment: first visual features obtained by using a method of VGT (Xiao et al., Video graph transformer for video question answering, ECCV 2022) are used, and second visual features are not used. Both local fusion and global fusion are performed.
First comparative example: HME (Fan et al., Heterogeneous memory enhanced multimodal attention model for video question answering, CVPR 2019)
Second comparative example: CoMem (Gao et al., Motion-appearance co-memory networks for video question answering, CVPR 2018)
Third comparative example: HCRN (Le et al., Hierarchical conditional relation networks for video question answering, CVPR 2020)
Fourth comparative example: HGA (Jiang et al., Reasoning with heterogeneous graph alignment for video question answering, AAAI 2020)
Fifth comparative example: B2A (Park et al., Bridge to answer: Structure-aware graph interaction network for video question answering, CVPR 2021)
Sixth comparative example: IGV (Li et al., Invariant grounding for video question answering, CVPR 2022)
Seventh comparative example: MHN (Peng et al., Multilevel hierarchical network with multi-scale sampling for video question answering, arXiv 2022)
Eighth comparative example: VGT
Ninth comparative example: HQGA (Xiao et al., Video as conditional graph hierarchy for multi-granular question answering, AAAI 2022)
Tenth comparative example: ML (an answer with the highest frequency of occurrence is selected)
Eleventh comparative example: PSAC (Li et al., Beyond rnns: Positional self-attention with co-attention for video question answering, AAAI 2019)
Twelfth comparative example: global fusion is performed by using an attention module and visual feature vectors obtained by using VGT.
Thirteenth comparative example: both local fusion and global fusion are performed by using an attention module and visual feature vectors obtained by using VGT.
Fourteenth comparative example: first visual features obtained by using VGT are used, and second visual features are not used. Global fusion is performed.
Fifteenth comparative example: appearance-based second visual features are used, and object graph-based first visual features are not used. A plurality of text features L₁ to Lₙ is identical to each other.

### [Evaluation Dataset]

Causal-VidQA: Wang et al., Causal attention for unbiased visual recognition, ICCV 2021
NExT-QA: Xiao et al., Next-qa: Next phase of question-answering to explaining temporal actions, CVPR 2021
MSVD-QA: Xu et al., Video question answering via gradually refined attention over appearance and motion, ACM international conference on Multimedia 2017
AGQA-2.0: Grunde-McLaughlin et al., Agqa 2.0: An updated benchmark for compositional spatio-temporal reasoning, arXiv 2022

### Comparison with Related Art

Referring to Table 1 below, the first exemplary embodiment showed higher performance than the first to fifth comparative examples on the Causal-VidQA dataset. In Table 1 below, ACC_{D} indicates answer accuracy for descriptive problem types, ACC_{E} indicates answer accuracy for explanatory problem types, ACC_{P} indicates answer accuracy for predictive problem types, ACC_{C} indicates answer accuracy for counterfactual problem types, and ACC_{A} indicates the overall accuracy for the dataset. In particular, the first exemplary embodiment showed high performance improvement for the predictive problem types and counterfactual problem types.

TABLE 1
Causal-VidQA (Test)

| | ACC_{D} | ACC_{E} | ACC_{P} | ACC_{C} | ACC_{A} |
|---|---|---|---|---|---|
| First | 63.36 | 61.44 | 28.91 | 30.92 | 46.16 |
| comparative | | | | | |
| example | | | | | |
| Second | 64.08 | 62.79 | 31.40 | 32.54 | 47.70 |
| comparative | | | | | |
| example | | | | | |
| Third | 65.35 | 61.61 | 32.56 | 32.65 | 48.04 |
| comparative | | | | | |
| example | | | | | |
| Fourth | 65.66 | 63.51 | 32.21 | 34.27 | 48.91 |
| comparative | | | | | |
| example | | | | | |
| Fifth | | | | | |
| comparative | 66.21 | 62.92 | 31.14 | 35.16 | 48.86 |
| example | | | | | |
| First | 72.02 | 71.59 | 39.63 | 42.78 | 56.51 |
| exemplary | | | | | |
| embodiment | | | | | |

Referring to Table 2 below, Test-C indicates answer accuracy for causal question types of the NExT-QA dataset, Test-T of the NExT-QA dataset indicates answer accuracy for temporal question types. Test-D of the NExT-QA dataset indicates answer accuracy for descriptive question types, and Test-A indicates the overall accuracy for the NExT-QA dataset. The overall accuracy of the first exemplary embodiment was higher than those of the first comparative example and the sixth to ninth comparative examples. In addition, for the MSVD-QA dataset, the first exemplary embodiment showed higher performance than those of the first comparative example and the sixth to ninth comparative examples.

TABLE 2

| | NExT-QA | | | | MSVD-QA |
|---|---|---|---|---|---|
| | Test-C | Test-T | Test-D | Test-A | Test |
| First | 46.76 | 48.89 | 57.37 | 49.16 | — |
| comparative | | | | | |
| example | | | | | |
| Sixth | 48.56 | 51.67 | 59.64 | 51.34 | 40.8 |
| comparative | | | | | |
| example | | | | | |
| Seventh | — | — | — | — | 40.4 |
| comparative | | | | | |
| example | | | | | |
| Eighth | 51.62 | 51.94 | 63.65 | 53.68 | 40.3 |
| comparative | | | | | |
| example | | | | | |
| Ninth | 49.04 | 52.28 | 59.43 | 51.75 | 41.2 |
| comparative | | | | | |
| example | | | | | |
| First | 51.78 | 52.05 | 63.63 | 53.81 | 41.35 |
| exemplary | | | | | |
| embodiment | | | | | |

Referring to Table 3 below, the accuracy performance of the tenth comparative example, the eleventh comparative example, the first comparative example, the third comparative example, and the first exemplary embodiment by problem type of the AGQA v2.0 dataset was evaluated (in Table 3, obj: object, rel: relationship, act: action, comp: comparison, recog: recognition). The performance with respect to all problems of the first exemplary embodiment was higher than the performance with respect to all the problems of the tenth comparative example, the eleventh comparative example, the first comparative example, and the third comparative example. In particular, the first exemplary embodiment showed significant performance improvement for question types of action recognition compared to those of the tenth comparative example, the eleventh comparative example, the first comparative example, and the third comparative example.

TABLE 3
AGQA v2.0

| | | Tenth | Eleventh | First | Third | First |
|---|---|---|---|---|---|---|
| | | comparative | comparative | comparative | comparative | exemplary |
| | | example | example | example | example | embodiment |
| Reas | Obj-rel | 9.39 | 37.84 | 37.45 | 40.33 | 43.1 |
| | Rel-act | 50 | 49.95 | 49.9 | 49.86 | 49.78 |
| | Obj-act | 50 | 50 | 49.97 | 49.85 | 50.05 |
| | Superlative | 21.01 | 33.2 | 33.21 | 33.55 | 35.4 |
| | Sequencing | 49.78 | 49.78 | 49.77 | 49.7 | 49.77 |
| | Exists | 50 | 49.94 | 49.96 | 50.01 | 50.42 |
| | Dur comp | 24.27 | 45.21 | 47.03 | 43.84 | 47.54 |
| | Act recog | 5.52 | 4.14 | 5.43 | 5.52 | 11.5 |
| Semantic | Object | 9.17 | 37.97 | 37.55 | 40.4 | 43.04 |
| | Relation | 50 | 49.95 | 49.99 | 49.96 | 50.37 |
| | Action | 30.11 | 46.85 | 47.58 | 46.41 | 47.83 |
| Structure | Query | 13.05 | 31.63 | 31.01 | 36.34 | 39.69 |
| | Compare | 50 | 49.49 | 49.71 | 49.22 | 49.74 |
| | Choose | 50 | 46.56 | 46.42 | 43.42 | 46.53 |
| | Logic | 50 | 49.96 | 49.87 | 50.02 | 50.06 |
| | Verify | 50 | 49.9 | 49.96 | 50.01 | 51.11 |

| | | | | | |
|---|---|---|---|---|---|
| Overall | 10.99 | 40.18 | 39.89 | 42.11 | 44.36 |

### [Effect of Multi-Level Fusion]

Referring to Table 4 below, the performance of the twelfth comparative example to the fourteenth comparative example and the fifth exemplary embodiment were compared to each other to confirm the effect of multi-level fusion including local fusion and global fusion. In Table 4 below, ACC_{D} indicates answer accuracy for descriptive problem types, ACC_{E} indicates answer accuracy for explanatory problem types, ACC_{P} indicates answer accuracy for predictive problem types, ACC_{C} indicates answer accuracy for counterfactual problem types, and ACC_{A} indicates the overall accuracy for the dataset. The twelfth comparative example and the thirteenth comparative example use the same visual feature vectors and the same attention module, but the twelfth comparative example performs only global fusion, and the thirteenth comparative example performs both local fusion and global fusion. Meanwhile, the fourteenth comparative example and the fifth exemplary embodiment use the same visual feature vectors and the same artificial intelligence model MD (see FIG. 2), but the fourteenth comparative example performs only global fusion, and the fifth exemplary embodiment performs both local fusion and global fusion. Considering that the overall performance of the thirteenth comparative example is higher than that of the twelfth comparative example and that the overall performance of the fifth exemplary embodiment is higher than that of the fourteenth comparative example, it may be seen that compared to performing only the global fusion, the multi-level fusion combining the local fusion and the global fusion contributes to performance improvement. In particular, it may be seen that the multi-level fusion may play an important role in improving performance for the predictive question types (in ACC_{P}).

TABLE 4
Causal-VidQA (Test)

| | ACC_{D} | ACC_{E} | ACC_{P} | ACC_{C} | ACC_{A} |
|---|---|---|---|---|---|
| Twelfth comparative | 72.24 | 70.95 | 37.77 | 42.49 | 55.86 |
| example | | | | | |
| Thirteenth comparative | 71.61 | 71.09 | 39.12 | 42.45 | 56.07 |
| example | | | | | |
| Fourteenth comparative | 70.16 | 68.98 | 34.81 | 40.83 | 53.69 |
| example | | | | | |
| Fifth exemplary | 72.02 | 71.59 | 39.63 | 42.78 | 56.51 |
| embodiment | | | | | |

### [Effect of Visual Features]

Referring to Table 5 below, the second exemplary embodiment uses object graph-based visual features, the third exemplary embodiment uses appearance-based visual features, the first exemplary embodiment uses object graph-based first visual features and appearance-based second visual features, and the fourth exemplary embodiment uses object graph-based first visual features, appearance-based second visual features, and motion-based third visual features. Test-C indicates answer accuracy for causal question types of the NExT-QA dataset, Test-T of the NExT-QA dataset indicates answer accuracy for temporal question types, Test-D of the NExT-QA dataset indicates answer accuracy for descriptive question types, and Test-A indicates the overall accuracy of the NExT-QA dataset. From Table 5, it may be confirmed that the first to fourth exemplary embodiments showed satisfactory performance for various types of visual features. Therefore, it may be seen that the present disclosure is not limited by the visual feature extraction modules MD1a and MD1b or the types of visual features.

TABLE 5
NExT-QA

| | Test-C | Test-T | Test-D | Test-A |
|---|---|---|---|---|
| Second exemplary | 49.76 | 51.04 | 61.07 | 52.01 |
| embodiment | | | | |
| Third exemplary | 50.49 | 51.34 | 62.56 | 52.73 |
| embodiment | | | | |
| First exemplary | 51.78 | 52.05 | 63.63 | 53.81 |
| embodiment | | | | |
| Fourth exemplary | 51.13 | 52.31 | 63.91 | 53.60 |
| embodiment | | | | |

### [Temporal-Axis Extension of Text Features]

Referring to Table 6 below, the fifteenth comparative example uses the same text feature for all time points or time periods by using a method of copying one text feature multiple times, whereas the third exemplary embodiment uses a plurality of different text features respectively corresponding to a plurality of time points or time periods. In Table 6 below, ACC_{D} indicates answer accuracy for descriptive problem types, ACC_{E} indicates answer accuracy for explanatory problem types, ACC_{P} indicates answer accuracy for predictive problem type, ACC_{C} indicates answer accuracy for counterfactual problem types, and ACC_{A} indicates the overall accuracy for the Causal-VidQA dataset.

In terms of the overall performance of ACC_{A}, the third exemplary embodiment showed superior performance than that of the fifteenth comparative example. Therefore, it may be seen that a method for the temporal-axis extension of text features according to the present disclosure, the method extracting different text features for each time, contributes to performance improvement.

In particular, the third exemplary embodiment showed higher performance improvement for the counterfactual problem types (in ACC_{C}) than that of the fifteenth comparative example.

TABLE 6
Causal-VidQA (Test)

| Method | ACC_{D} | ACC_{E} | ACCₚ | ACC_{c} | ACC_{A} |
|---|---|---|---|---|---|
| Fifteenth | 67.01 | 62.37 | 33.32 | 30.91 | 48.40 |
| comparative | | | | | |
| example | | | | | |
| Third | 71.91 | 69.35 | 35.92 | 43.38 | 55.14 |
| exemplary | | | | | |
| embodiment | | | | | |

[Temporal Similarity with Correct Answer]

In order to verify whether the exemplary embodiments of the present disclosure are effective in understanding temporal context, a similarity between a correct answer vector and a global fusion vector corresponding to each time point or time period was calculated.

For example, for a question “which objects were they behind before standing up but after lying on a bed?”, the correct answer vector showed the highest similarity to a global fusion feature corresponding to a time point corresponding to “just before standing” in the first exemplary embodiment. That is, it may be seen that the first exemplary embodiment may learn the global fusion feature related to the correct answer.

In addition, for a question “While putting on a shoe, which object did the person close?”, the correct answer vector showed the highest similarity to a global fusion feature corresponding to a time point when the person interacted with the shoe and closed a laptop in the first exemplary embodiment. That is, it may be seen that the first exemplary embodiment may learn the global fusion feature related to the correct answer.

In addition, for a question “Was the person tidying up the object they were behind first before or after tidying something on the thing they stood on?”, the correct answer vector showed the highest similarity to a global fusion feature corresponding to a time point when the person changes an action between a time point corresponding to “tidying the floor” and a time point corresponding to “tidying the object they were behind” in the first exemplary embodiment. That is, it may be seen that the first exemplary embodiment may learn the global fusion feature related to the correct answer.

So far, while the exemplary embodiments of the present disclosure have been shown and described above, those skilled in the art will be able to appreciate that various changes may be made in the forms and details without departing from the spirit and scope of the present exemplary embodiments as defined by the appended claims and their equivalents.

What is claimed is:

1. An electronic device for multimodal temporal-axis fusion artificial intelligence models, the electronic device comprising:
a storage unit; and
a processor,
wherein the processor obtains a plurality of first visual features respectively corresponding to a plurality of different time points or time periods from a video, obtains a plurality of text features respectively corresponding to the plurality of time points or time periods from text, obtains a plurality of first local fusion features, respectively corresponding to the plurality of time points or time periods, from the plurality of first visual features and the plurality of text features by fusing the first visual features and the text features, which correspond to a same time point or time period, and obtains at least one global fusion feature from the plurality of first local fusion features, and
in order to obtain the plurality of text features, the processor obtains a plurality of first intermediate text features from the text, obtains a plurality of second intermediate text features respectively corresponding to the plurality of time points or time periods from the plurality of first intermediate text features by using a plurality of mapping layers respectively corresponding to the plurality of time points or time periods, and obtains the plurality of text features from the plurality of second intermediate text features by changing dimensions of the second intermediate text features.

2. The electronic device of claim 1, wherein the number of the plurality of first intermediate text features is different from the number of the plurality of second intermediate text features.

3. The electronic device of claim 1, wherein a dimension of each of the plurality of text features is a same as a dimension of each of the plurality of first visual features.

4. The electronic device of claim 1, wherein, in order to obtain the plurality of first local fusion features, the processor obtains the first local fusion features from the first visual features and the text features by using convolution.

5. The electronic device of claim 1, wherein, in order to obtain the plurality of first local fusion features, the processor obtains a plurality of first intermediate local fusion features from the first visual features and the text features, obtains a plurality of second intermediate local fusion features from the first intermediate local fusion features by using convolution, and obtains the first local fusion features from the first visual features and the second intermediate local fusion features.

6. The electronic device of claim 1, wherein, in order to obtain the plurality of first visual features, the processor obtains a plurality of object features from the video, obtains a plurality of object graphs from the plurality of object features, and obtains the plurality of first visual features from the plurality of object graphs.

7. The electronic device of claim 1, wherein the processor obtains a plurality of second visual features respectively corresponding to the plurality of time points or time periods from the video, obtains a plurality of second local fusion features, respectively corresponding to the plurality of time points or time periods, from the plurality of second visual features and the plurality of text features by fusing the second visual features and the text features, which correspond to the same time point or time period, obtains a plurality of third local fusion features respectively corresponding to the plurality of time points or time periods from the plurality of first local fusion features and the plurality of second local fusion features, and obtains the at least one global fusion feature from the plurality of third local fusion features.

8. The electronic device of claim 1, wherein, in order to obtain the at least one global fusion feature, the processor obtains the at least one global fusion feature from the plurality of first local fusion features by using self-attention.

9. The electronic device of claim 1, wherein the text comprises a question, and
the processor obtains an answer to the question by using the at least one global fusion feature.

10. The electronic device of claim 9, wherein the at least one global fusion feature comprises a plurality of global fusion features, and
in order to obtain the answer to the question, the processor obtains an aggregated vector from the plurality of global fusion features, obtains a plurality of option features respectively from a plurality of options, and obtains the answer to the question from the aggregated vector and each option feature.

11. The electronic device of claim 1, wherein the processor classifies, searches, predicts, or generates the video by using the at least one global fusion feature.

12. An operation method of an electronic device for multimodal temporal-axis fusion artificial intelligence models, the operation method comprising:
obtaining a plurality of first visual features respectively corresponding to a plurality of different time points or time periods from a video;
obtaining a plurality of text features respectively corresponding to the plurality of time points or time periods from text;
obtaining a plurality of first local fusion features, respectively corresponding to the plurality of time points or time periods, from the plurality of first visual features and the plurality of text features by fusing the first visual features and the text features, which correspond to a same time point or time period; and
obtaining at least one global fusion feature from the plurality of first local fusion features, and
wherein the obtaining of the plurality of text features comprises:
obtaining a plurality of first intermediate text features from the text;
obtaining a plurality of second intermediate text features respectively corresponding to the plurality of time points or time periods from the plurality of first intermediate text features by using a plurality of mapping layers respectively corresponding to the plurality of time points or time periods; and
obtaining the plurality of text features from the plurality of second intermediate text features by changing dimensions of the second intermediate text features.

13. The operation method of claim 12, wherein the number of the plurality of first intermediate text features is different from the number of the plurality of second intermediate text features.

14. The operation method of claim 12, wherein a dimension of each of the plurality of text features is a same as a dimension of each of the plurality of first visual features.

15. The operation method of claim 12, wherein the obtaining of the plurality of first local fusion features comprises:
obtaining the first local fusion features from the first visual features and the text features by using convolution.

16. The operation method of claim 12, wherein the obtaining of the plurality of first local fusion features comprises:
obtaining a plurality of first intermediate local fusion features from the first visual features and the text features;
obtaining a plurality of second intermediate local fusion features from the first intermediate local fusion features by using convolution; and
obtaining the first local fusion features from the first visual features and the second intermediate local fusion features.

17. The operation method of claim 12, wherein the obtaining of the plurality of first visual features comprises:
obtaining a plurality of object features from the video;
obtaining a plurality of object graphs from the plurality of object features; and
obtaining the plurality of first visual features from the plurality of object graphs.

18. The operation method of claim 12, further comprising:
obtaining a plurality of second visual features respectively corresponding to the plurality of time points or time periods from the video;
obtaining a plurality of second local fusion features, respectively corresponding to the plurality of time points or time periods, from the plurality of second visual features and the plurality of text features by fusing the second visual features and the text features, which correspond to the same time point or time period; and
obtaining a plurality of third local fusion features respectively corresponding to the plurality of time points or time periods from the plurality of first local fusion features and the plurality of second local fusion features,
wherein the obtaining of the at least one global fusion feature comprises:
obtaining the at least one global fusion feature from the plurality of third local fusion features.

19. The operation method of claim 12, wherein the obtaining of the at least one global fusion feature comprises:
obtaining the at least one global fusion feature from the plurality of first local fusion features by using self-attention.

20. The operation method of claim 12, further comprising:
obtaining an answer to a question by using the at least one global fusion feature,
wherein the text comprises the question.

21. The operation method of claim 20, wherein the at least one global fusion feature comprises a plurality of global fusion features, and
the obtaining of the answer to the question comprises:
obtaining an aggregated vector from the plurality of global fusion features;
obtaining a plurality of option features respectively from a plurality of options; and
obtaining the answer to the question from the aggregated vector and each option feature.

22. The operation method of claim 12, further comprising:
classifying, searching, predicting, or generating the video by using the at least one global fusion feature.
